(19) United States
(12) Patent Application Publication
(10) Pub. No.: US 2025/0349106 A1
(43) Pub. Date: Nov. 13, 2025

(54) RADIO FREQUENCY IDENTIFICATION AND MACHINE LEARNING FOR CLOTHING IDENTIFICATION

(71) Applicant: TOSHIBA GLOBAL COMMERCE SOLUTIONS, INC., Durham, NC (US)

(72) Inventors: Wendy K. DARBY, Raleigh, NC (US); Patricia S. HOGAN, Raleigh, NC (US); Cassio M. PEDRÃO, São Paulo (BR)

(21) Appl. No.: 18/657,674

(22) Filed: May 7, 2024

(51) Int. Cl. G06V 10/70; G06K 7/10; G06K 19/07; G06V 20/60

(52) U.S. Cl. CPC G06V 10/70; G06K 7/10297; G06K 19/0723; G06V 20/60

(57) ABSTRACT

Method and apparatus for machine learning are provided. A set of images depicting a user selecting an item of clothing is accessed, and a predicted type and a predicted size of the item of clothing is generated based on processing at least one of the set of images using a machine learning model. Using a radio frequency identification (RFID) tag on the item of clothing, a true type and a true size of the item of clothing are identified. The predicted type and the predicted size are compared to the true type and the true size. The machine learning model is trained based on the comparison.

### BACKGROUND

The present disclosure relates to machine learning, including, to using machine learning to identify items of clothing.

### BRIEF DESCRIPTION OF THE DRAWINGS

FIG. 1 depicts an example environment for item recognition using machine learning, according to some embodiments of the present disclosure.

FIG. 2 is a flow diagram depicting an example method for training machine learning model(s) to perform item recognition, according to some embodiments of the present disclosure.

FIG. 3 is a flow diagram depicting an example method for using machine learning model(s) to perform item recognition, according to some embodiments of the present disclosure.

FIG. 4 is a flow diagram depicting an example method for predicting item size, according to some embodiments of the present disclosure.

FIG. 5 is a flow diagram depicting an example method for updating machine learning models, according to some embodiments of the present disclosure.

FIG. 6 depicts an example computing device for machine learning-based item recognition, according to some embodiments of the present disclosure.

### DETAILED DESCRIPTION

Embodiments of the present disclosure provide techniques to train machine learning models to predict item types and sizes accurately.

In some embodiments, radio frequency identification (RFID) tags are used to help train machine learning model(s) to identify clothing items (e.g., at a self-checkout). In some embodiments, the system may additionally or alternatively access other data, such as images captured in the environment to evaluate user movements, social media data, and the like in order to identify clothing items and/or item sizes, such as based on where the user picked up the clothing item. To assist with training the machine learning model(s) to recognize clothing items, RFID tags on the clothing items can be leveraged. For example, the system may compare the model prediction (e.g., predicted size and item type) and the true value (e.g., the type and size indicated by the RFID tag). By leveraging such tags and/or image analysis of user movements, the system is able to learn to predict item type and sizes accurately in the absence of such RFID tags. In many conventional settings, such recognition is difficult or impossible. For example, items of clothing are often folded or otherwise obscured during the process, causing image recognition techniques to struggle to differentiate items (and making size prediction virtually impossible).

### Advantages of RFID-Based Model Training

In many conventional systems, it is difficult or impossible to train item recognition models to recognize which clothing items and sizes users have selected.

Though some systems are able to recognize some items selected by users (e.g., groceries), such systems are generally non-operable for clothing items. That is, because clothing items are generally flexible and often folded, captured images (e.g., depicting the item at a checkout station, such as a self-checkout) are often confusing or misleading. This causes machine learning models to fail to converge during training, resulting in inaccurate and unreliable predictions. As a result, existing systems simply cannot be used to predict clothing item type and size.

As a direct result, frictionless and/or self-checkout systems generally do not exist in environments that sell clothing items (or other flexible or deformable items that are difficult to visually identify). Embodiments of the present disclosure provide improved techniques and architectures to train item recognition models to accurately recognize clothing, and predict which clothing item type(s) and size(s) have been selected by users.

### Example Environment for Item Recognition using Machine Learning

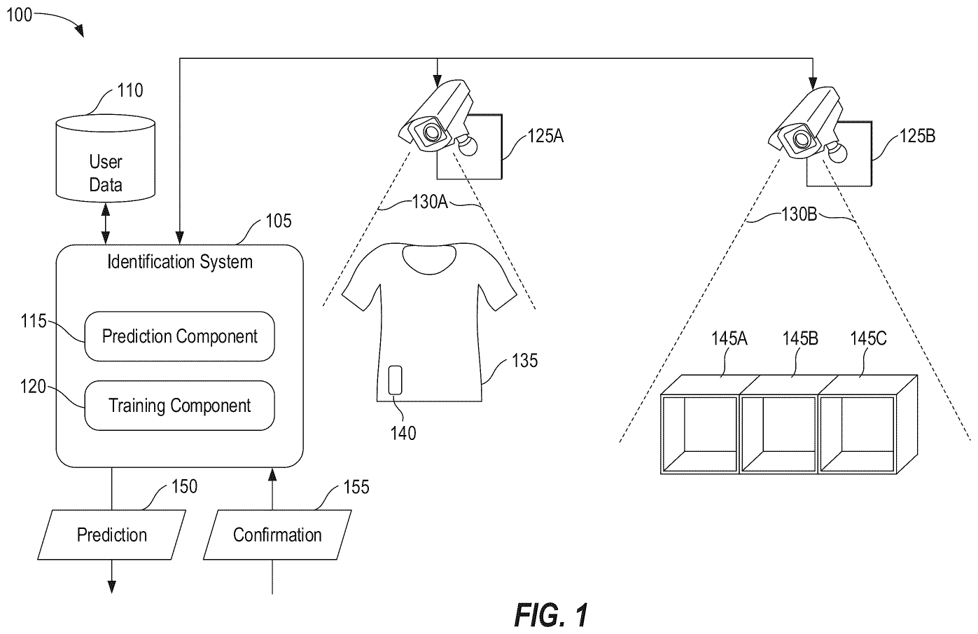

FIG. 1 depicts an example environment 100 for item recognition using machine learning, according to some embodiments of the present disclosure.

In the illustrated environment 100, an identification system 105 is communicably coupled with a database of user data 110, as well as one or more cameras 125A-B. Although illustrated as a discrete system for conceptual clarity, in embodiments, the identification system 105 may be implemented using hardware, software, or a combination of hardware and software across any number of devices and systems. In the illustrated environment 100, cameras 125 are installed, arranged, or otherwise configured to capture images depicting various aspects of the environment. The camera 125B is arranged to capture images of one or more locations where physical items (e.g., clothing items) are stored or displayed (e.g., in cubbies 145A-C), as indicated by sightlines 130B.

For example, clothing items (such as shirts, pants, and the like) may be folded and stacked in the cubbies 145 and users (e.g., customers) may be allowed to peruse the items and select which item(s) they would like to purchase. In many retail environments, clothing items are arranged in the space based on characteristics such as the type of item, the size of the item, and the like. In some aspects, such physical arrangement is referred to as a planogram (e.g., a diagram showing where specific products are placed on shelves or other displays). For example different types of pants (e.g., with different hems, different color, different pleating, and the like) may be stored in the cubbies 145, with one type in the cubby 145A, another in the cubby 145B, and a third in the cubby 145C. As another example, different sizes of the same type of item may be stored in the cubbies 145, such as one size in the cubby 145A, another size in the cubby 145B, and a third size in the cubby 145C.

In some embodiments, in addition to or instead of storing different types or sizes of clothing in different areas (e.g., different cubbies 145), the items may be arranged within an area based on factors such as type or size. For example, the cubby 145A may store pants of a single type, where larger sizes are at the bottom of the stack and smaller sizes are near the top. Although the illustrated example depicts cubbies 145, the camera 125B may generally be configured to capture images of any display or location where items can be selected, such as shelves, tables, and the like. In some embodiments, the items are generally arranged in the physical space according to a planogram or other mapping indicating the arrangement (e.g., indicating what type of item(s) are located in any given area, indicating how the size(s) of each item are arranged within an area, and the like).

In the illustrated example, the camera 125A is configured to capture images of items as they are presented by the user for purchase or selection (e.g., at a self-checkout). Specifically, in the illustrated example, the user is selecting a shirt 135. Although the illustrated shirt 135 is readily recognizable (e.g., laid flat without overlap or folding) for conceptual clarity, as discussed above, such items are often presented (at the camera 125A) by users in less straightforward configurations, such as folded, wrapped up, or otherwise not easily recognizable (particularly making the size of the item difficult or impossible to determine).

In the illustrated environment 100, the identification system 105 accesses image(s) captured by the cameras 125 and evaluates these images and/or other data to generate predictions 150 indicating what item(s) (e.g., what type and size of item) the user is selecting. In the depicted example, the identification system 105 includes a prediction component 115 and a training component 120. Although depicted as discrete components for conceptual clarity, in some embodiments, the operations of the depicted components (and others not illustrated) may be combined or distributed across any number of components and systems.

In some embodiments, during a training phase, the training component 120 can evaluate the image(s) and/or other data to generate predictions 150 using one or more machine learning models. The training component 120 may then use various feedback mechanisms to train the model(s) (e.g., to update the parameters of the model(s)) to be more accurate. For example, in some embodiments, items of clothing in the environment 100 may be associated with identifiers or tags, such as RFID tag 140. In some embodiments, the training component 120 can scan or detect this RFID tag 140 to learn the actual or true item features (e.g., the true type and size of the shirt 135). By comparing this true size and/or type to the generated prediction 150, the training component 120 can update the models (e.g., using backpropagation) to iteratively generate more accurate predictions.

In some embodiments, some or all of the items may include identifiers (such as RFID tags 140) during the training phase, but may lack such identifiers after training. For example, when the identification system 105 is deployed in the environment 100, RFID tags 140 may be added to the various items to allow the system to learn during use. After training, the managers of the environment 100 may refrain from adding RFID tags 140 to items, allowing the identification system 105 to rely on its generated predictions 150.

As another example of feedback during training, in some embodiments, the training component 120 may receive confirmation 155 from users (e.g., from the user selecting the items) as the ground truth. For example, the prediction 150 may indicate the predicted item type, size, and the like, and the user may provide confirmation 155 of the actual or true item type, size, and the like. In some embodiments, this confirmation 155 can be used as the target variable to train the model(s) (e.g., by comparing the predicted values with the indicated true values). In some embodiments, as discussed above, after training is complete, the identification system 105 may not receive or rely upon confirmations 155.

In some embodiments, to predict the type of the item (e.g., the shirt 135), the identification system 105 may evaluate the image(s) captured by the camera 125A (e.g., using a convolutional neural network) and/or the image(s) captured by the camera 125B. For example, the images provided by the camera 125A may allow the identification system 105 to infer that the item is a shirt 135 (even if the specific type of shirt cannot be ascertained). Then, the identification system 105 may evaluate the image(s) captured by camera 125B (or other cameras in the space) to determine what type and/or size of shirt 135 the user selected. For example, using the camera 125B (e.g., by evaluating images from the camera 125B using object recognition or other computer vision models), the identification system 105 may determine that the user selected an item from the bottom of a stack in the cubby 145B. Based on the item diagram, the identification system 105 can thereby determine the type and/or size of shirt 135 (e.g., if the diagram indicates that the cubby 145B stores shirts of type “crew neck”, with size “large” at the bottom of the stack).

In the illustrated example, therefore, when the identification system 105 identifies or recognizes the shirt 135 (selected by a given user) at the checkout or other station, the identification system 105 can infer that the shirt 135 is the same item that the same user selected (as indicated by the camera 125B), and the prediction 150 may indicate that the item is a shirt 135 of type crew neck and size large.

In some embodiments, the type and/or size of the item may additionally or alternatively be predicted or inferred using other data, such as user data 110. For example, in some embodiments, the identification system 105 may access and evaluate one or more historical item or purchase records for the user (in the user data 110), inferring that the user is likely purchasing a similar size and/or type to what they previously selected. For example, if the user data 110 indicates that the given user generally buys size “medium” for shirts, the identification system 105 may infer that when a shirt 135 is detected, it is likely to be size medium.

As another example, the identification system 105 may access and evaluate other information (such as from social media) that may be indicative of sizing. For example, the identification system 105 may determine or estimate (based on the user data 110) the age or size of the user's child (e.g., based on posts on social media, based on historical trends in sizing, such as if the user purchases progressively larger child-size items, and the like). If the detected item is a child's item of clothing, therefore the identification system 105 may predict the size based on this progression or information. For example, if the user previously selected or purchased a size 6-month outfit, the identification system 105 may determine how much time has elapsed since that purchase to infer the size of the new item.

As yet another example, in some embodiments, the identification system 105 may evaluate image(s) depicting the user themselves (e.g., as they walk through the environment 100) and estimate the size of the user based on these images. If the identification system 105 detects that a shirt 135 or other item is being selected, the identification system 105 may infer the size based on the determined size of the user. In some embodiments, if the selected size (e.g., determined based on the camera 125B or user input) differs from the estimated size of the user, the identification system 105 may take various steps such as suggesting a different size (e.g., indicating that the item size appears to not match the user's size). In some embodiments, if the mismatch can be explained by other data (e.g., historical purchases in the user data 110, such as records indicating that the user often purchases clothing for their child, spouse, and the like), the identification system 105 may refrain from generating such suggestions.

In the illustrated example, once the model(s) are trained, the prediction component 115 may use the trained models for runtime inferencing. For example, as discussed above, the prediction component 115 may use similar approaches and techniques to generate predictions 150 indicating the type, size, or other relevant feature of items of clothing (such as the shirt 135) without referencing or evaluating tags or identifiers such as the RFID tag 140 and/or confirmation 155. In this way, the identification system 105 learns to provide accurate and robust predictions identifying characteristics of physical items that were previously extremely difficult (or impossible) to identify using machine learning.

Although a single environment 100 is depicted for conceptual clarity, in some embodiments, training data may be aggregated across any number of environments (e.g., multiple retail stores selling the same item(s)).

In some embodiments, in addition to or instead of predicting the type and/or size of clothing items, the identification system 105 may perform other analysis to verify or otherwise facilitate transactions. For example, in some embodiments, the identification system 105 may check whether the number of items of clothing collected by the user (e.g., determined or identified using the above-discussed machine learning model(s) matches the number of tags read at the checkout area (e.g., the number of RFID tags identified).

In some embodiments, the identification system 105 may determine whether the identified RFID codes correspond to the items that were selected (or at least limit the universe of potential items), such as when the identification system 105 cannot conclusively determine the size or type of the item. For example, when the same (or a similar) print is on different clothing items (e.g., a pair of pants and a shirt with the same print), the identification system 105 may use the RFID information to conclude and learn which specific item was selected.

In some embodiments, using images depicting area(s) near fitting room(s), the identification system 105 can track the items of clothing taken from the racks to determine whether the same pieces are leaving with the user, or if the items were left on the fitting room's exit hanger (or other area where discarded or unselected items are placed). That is, images depicting users exiting the fitting area may be processed to determine whether the user retained the item(s) of clothing (e.g., whether they are carrying them) or whether they returned the items to the designated return area. In some embodiments, if the identification system 105 determines that the user is not retaining an item and that the item was also not placed on the designated rack or area, the identification system 105 may determine or infer that the user has hidden or concealed the item (e.g., in their bag, or obscured by another item of clothing). Such analysis may enable the identification system 105 to prevent potential losses.

### Example Method for Training Machine Learning Model(s) to Perform Item Recognition

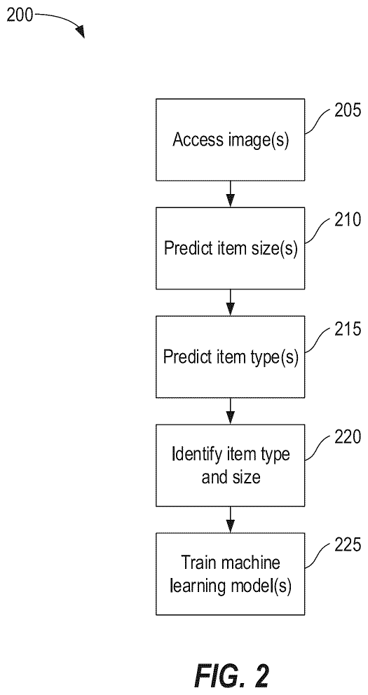

FIG. 2 is a flow diagram depicting an example method 200 for training machine learning model(s) to perform item recognition, according to some embodiments of the present disclosure. In some embodiments, the method 200 is performed by an identification system, such as the identification system 105 of FIG. 1.

At block 205, the identification system accesses one or more images captured in a physical environment (e.g., via the cameras 125 of FIG. 1). As used herein, “accessing” data may generally include receiving, retrieving, requesting, obtaining, generating, collecting, or otherwise gaining access to the data. For example, the cameras 125 may transmit or otherwise provide the image(s) to the identification system for evaluation.

In some embodiments, as discussed above, the image(s) generally depict items (e.g., clothing items) in the space and/or user(s) selecting the item(s). For example, the image(s) may depict shelves, racks, cubbies, tables, or other areas or locations where items are displayed or otherwise provided for selection. As another example, the image(s) may depict a region or area where transactions are completed or finalized (e.g., a self-checkout kiosk).

At block 210, the identification system predicts the size(s) of the selected item(s) depicted in the image(s). In some embodiments, as discussed above, the identification system can predict the item size(s) using machine learning. For example, the identification system may process one or more of the images using one or more machine learning models to predict or infer the sizing. In some embodiments, as discussed above, the identification system may additionally or alternatively evaluate other information (such as user data 110 of FIG. 1) to predict the size. In some embodiments, the identification system may predict the size(s) based on determining or identifying the location(s) from which the user selected the item(s). For example, as discussed above, the identification system may identify the item type and/or user at the checkout area, and evaluate the image(s) to determine where the user retrieved the item (e.g., which cubby, where on a table, where on a rack of clothing, and the like). By comparing the selection location to the planogram or other mapping of item locations in the space, the identification system can predict the size that was selected.

At block 215, the identification system predicts the type(s) of the selected item(s). In some embodiments, as discussed above, the identification system predicts the type(s) based on processing one or more image(s) using machine learning models. For example, as discussed above, the identification system may use one or more machine learning models trained to predict or identify clothing items using computer vision. In some embodiments, as discussed above, the identification system may predict the type(s) based on determining or identifying the location(s) from which the user selected the item(s). For example, as discussed above, the identification system may identify the item category and/or user at the checkout area, and evaluate the image(s) to determine where the user retrieved the item (e.g., which cubby, where on a table, where on a rack of clothing, and the like). By comparing the selection location to the planogram or other mapping of item locations in the space, the identification system can predict the type that was selected (e.g., the type and brand of pants that the user selected).

At block 220, the identification system identifies the true or actual item type(s) and size(s) for the selected item(s). For example, as discussed above, the identification system may identify the true information based on detecting an RFID tag attached to the clothing item. That is, the tag may indicate the identifier of the clothing, allowing the identification system to lookup or otherwise determine the type and size of the clothing. In some embodiments, as discussed above, such RFID tags (or other ground truth identifiers) may be available during training (e.g., when the model is being trained to identify one or more new items, such as when a new item is added to the environment's inventory). Such tags may be unavailable or not used during runtime (e.g., after the identification system learns to identify the item), as discussed above.

At block 225, the identification system trains one or more machine learning models based on the prediction(s) and determined true value(s) for the items. Generally, the particular techniques used to train the model(s) may vary depending on the particular architecture of the mode. For example, if the model(s) include convolutional neural networks for computer vision, the identification system may compare the generated prediction(s) (e.g., the predicted size and/or type of the item) against the actual true value(s) (e.g., the determined type and size, such as based on the RFID tag) to generate a loss (e.g., a cross-entropy loss). This loss may then be used to update one or more parameters of the model (e.g., using backpropagation).

Although the illustrated example depicts an iterative process (e.g., training the model based on individual samples or records using stochastic gradient descent) for conceptual clarity, in some embodiments, the identification system may use multiple such records to update the mode in batches (e.g., using batch gradient descent). As discussed above, the training data may generally be received from any number and variety of sources, including cameras local in a single physical environment, cameras distributed across multiple stores, and the like.

In this way, by leveraging imagery from one or more locations in the environment, mappings indicating item placement in the environment, and/or RFID tags or other identifiers associated with the items, the identification system is able to train machine learning model(s) to accurately and reliably identify items as they are selected by users. This substantially improves the functionality of the identification system and environment in general.

### Example Method for Using Machine Learning Model(s) to Perform Item Recognition

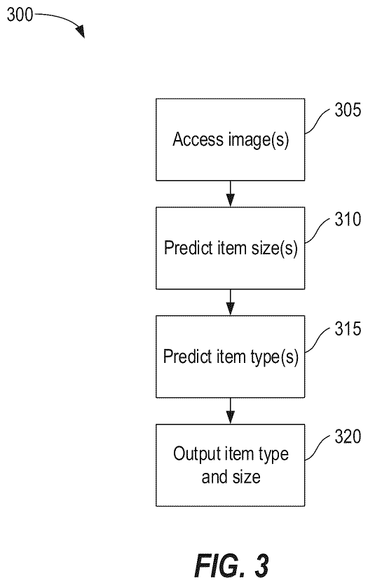

FIG. 3 is a flow diagram depicting an example method 300 for using machine learning model(s) to perform item recognition, according to some embodiments of the present disclosure. In some embodiments, the method 300 is performed by an identification system, such as the identification system 105 of FIG. 1. In some embodiments, the method 300 uses trained machine learning models (e.g., trained using the method 200 of FIG. 2) to identify items.

At block 305, the identification system accesses one or more images captured in a physical environment (e.g., via the cameras 125 of FIG. 1). For example, the cameras may transmit or otherwise provide the image(s) to the identification system for evaluation. In some embodiments, as discussed above, the image(s) generally depict items (e.g., clothing items) in the space and/or user(s) selecting the item(s). For example, the image(s) may depict shelves, racks, cubbies, tables, or other areas or locations where items are displayed or otherwise provided for selection. As another example, the image(s) may depict a region or area where transactions are completed or finalized (e.g., a self-checkout kiosk).

At block 310, the identification system predicts the size(s) of the selected item(s) depicted in the image(s). In some embodiments, as discussed above, the identification system can predict the item size(s) using machine learning. For example, the identification system may process one or more of the images using one or more trained machine learning models to predict or infer the sizing. In some embodiments, as discussed above, the identification system may additionally or alternatively evaluate other information (such as user data 110 of FIG. 1) to predict the size. In some embodiments, the identification system may predict the size(s) based on determining or identifying the location(s) from which the user selected the item(s). For example, as discussed above, the identification system may identify the item type and/or user at the checkout area, and evaluate the image(s) to determine where the user retrieved the item (e.g., which cubby, where on a table, where on a rack of clothing, and the like). By comparing the selection location to the planogram or other mapping of item locations in the space, the identification system can predict the size that was selected.

At block 315, the identification system predicts the type(s) of the selected item(s). In some embodiments, as discussed above, the identification system predicts the type(s) based on processing one or more image(s) using machine learning models. For example, as discussed above, the identification system may use one or more trained machine learning models trained to predict or identify clothing items using computer vision. In some embodiments, as discussed above, the identification system may predict the type(s) based on determining or identifying the location(s) from which the user selected the item(s). For example, as discussed above, the identification system may identify the item category and/or user at the checkout area, and evaluate the image(s) to determine where the user retrieved the item (e.g., which cubby, where on a table, where on a rack of clothing, and the like). By comparing the selection location to the planogram or other mapping of item locations in the space, the identification system can predict the type that was selected (e.g., the type and brand of pants that the user selected).

At block 320, the identification system outputs the predicted item type and/or size. For example, as discussed above, the identification system may output the predictions via a display (e.g., requesting user confirmation). In some embodiments, outputting the prediction(s) can include entering or adding the predicted item(s) to the ongoing transaction, or finalizing or completing the transaction based on the items. In some embodiments, the identification system may output the prediction(s) for confirmation in response to determining that the prediction is not sufficiently reliable (e.g., confidence is below a threshold). For example, if the identification system predicts a range of sizes (rather than a single size), the identification system may ask the user to confirm what specific size was selected.

In some embodiments, the identification system can take further action based on the predictions. For example, in some embodiments, the identification system can update an item tracking or inventory system (e.g., to update the records to reflect that the item was selected and is no longer available in inventory, or to reduce the number of items recorded as being available). As another example, in some embodiments, the identification system can output suggestions or input regarding the items. For example, if the identification system determines that the predicted item size does not match the size of the user (or the size of the individual for whom the user is selected the item, such as the user's relative or friend), the identification system may indicate that the item may not fit properly.

In this way, by leveraging imagery from one or more locations in the environment, mappings indicating item placement in the environment, and the like, the identification system is able to use trained machine learning model(s) to accurately and reliably identify items as they are selected by users. This substantially improves the functionality of the identification system and environment in general.

### Example Method for Predicting Item Size

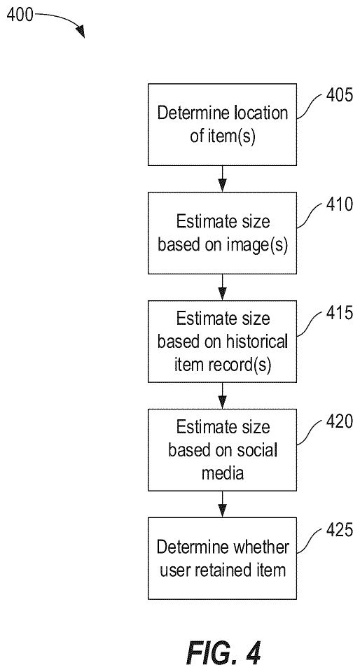

FIG. 4 is a flow diagram depicting an example method 400 for predicting item size, according to some embodiments of the present disclosure. In some embodiments, the method 400 is performed by an identification system, such as the identification system 105 of FIG. 1. In some embodiments, the method 400 provides additional detail for block 210 of FIG. 2 and/or block 310 of FIG. 3.

At block 405, the identification system determines the location(s) from which the item(s) were selected. For example, as discussed above, the identification system may evaluate one or more images depicting the user selecting item(s), and determine the specific location of each item. In some embodiments, as discussed above, the identification system may access a mapping (e.g., a planogram) indicating the arrangement of item(s) in the space (e.g., by type, size, and the like). For example, the mapping may indicate that a given item type (e.g. pleated khaki pants) are located on a given table, with each pile of folded pants corresponding to a given size. In response to identifying what pile the user selected the item from, the identification system may therefore infer the size and/or type of the selected item.

At block 410, the identification system estimates the size of the selected item(s) based on the depiction of the item(s) in one or more image(s). For example, as discussed above, the identification system may process the image(s) using one or more trained machine learning models, where the model(s) have been trained (as discussed above) to identify item size.

At block 415, the identification system estimates the size of the item based on a set of historical records (e.g., in the user data 110 of FIG. 1) for the user. For example, as discussed above, the identification system may determine what size(s) the user previously purchased. Based on this information, the identification system may infer or estimate what size the user is currently selecting. For example, if the identification system determines that the user generally selects a particular size, the identification system may infer that the user has selected the same size. As another example, the identification system may determine whether the predicted item size (e.g., predicted based on the item location or other information) is compatible to the historical item records. For example, if the item is a child's size medium, the identification system may determine whether the user has previously selected child-sized clothing (and if so, if medium is compatible with that previous selection).

In some embodiments, the identification system can evaluate trends in the historical data to estimate the size. For example, if the historical item records indicate that the user previously selected infant clothing in increasing sizes, the identification system may infer (based on the trend) the size of the current items. For example, the identification system may determine how much time has elapsed since the last purchase and the size that was purchased, and extrapolate to predict the current size (e.g., suggesting twelve month clothing if the user previously selected six month clothing approximately six months ago).

At block 420, the identification system estimates the size of the item based on social media data. For example, as discussed above, the identification system may evaluate social media posts (e.g., text posts), pictures, and the like to estimate the size. In some embodiments, for example, the identification system may determine whether the user has children (or other individuals for whom the user shops), estimate the size of the user, and the like.

At block 425, the identification system determines whether the user retained the selected item(s), as discussed above. For example, the identification system may evaluate image(s) of a deposit area (e.g., at the exit of a fitting room) where users place items they have decided not to purchase. Based on comparing the item(s) carried by the user before and after exiting the fitting area, the identification system can determine whether any of the previously selected items have been returned.

Although the illustrated example depicts a number of ways to estimate item size, each block in the method 400 may generally be optional and may or may not be used depending on the particular implementation. For example, the identification system may evaluate historical sales but not social media data, or may evaluate only images captured in the space.

Additionally, in some embodiments, other techniques not depicted in FIG. 4 may be used to estimate the size. For example, in some embodiments, the identification system may evaluate images captured of the user in the space (e.g., as they select items) to estimate the size of the user. This estimation may then be used to help predict the item size(s), as discussed above.

In some embodiments, as discussed above, determining or estimating the item size may include estimating a range of sizes. For example, if the identification system determines that the user selected an item from a given region of a product rack, the identification system may infer or predict a range (e.g., that the item is between sizes four and ten) if a more specific prediction is not available (e.g., the determined location is a range).

### Example Method for Updating Machine Learning Models

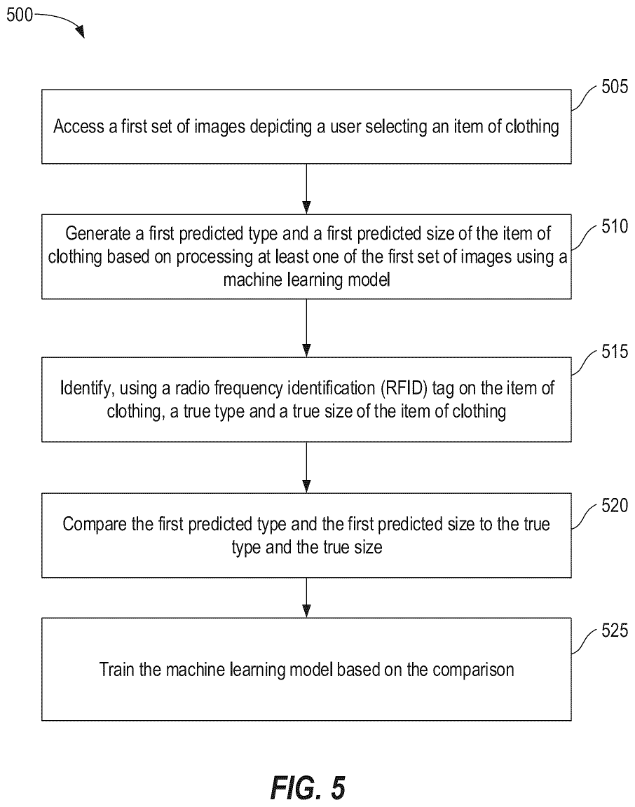

FIG. 5 is a flow diagram depicting an example method for updating machine learning models, according to some embodiments of the present disclosure.

At block 505, a first set of images depicting a user selecting an item of clothing (e.g., the shirt 135 of FIG. 1) is accessed (e.g., via one or more cameras 125 of FIG. 1).

At block 510, a first predicted type and a first predicted size of the item of clothing (e.g., the prediction 150 of FIG. 1) are generated based on processing at least one of the first set of images using a machine learning model.

At block 515, using a radio frequency identification (RFID) tag (e.g., the RFID tag 140 of FIG. 1) on the item of clothing, a true type and a true size of the item of clothing are identified.

At block 520, the first predicted type and the first predicted size are compared to the true type and the true size.

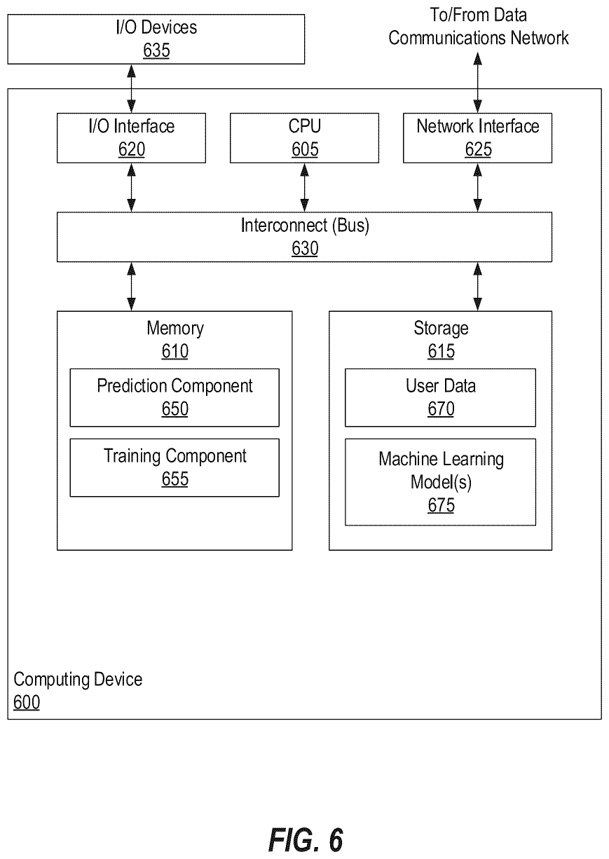

At block 525, the machine learning model (e.g., the machine learning models 675 of FIG. 6) is trained based on the comparison.

### Example Computing Device for Machine Learning-Based Item Recognition

FIG. 6 depicts an example computing device 600 for machine learning-based item recognition, according to some embodiments of the present disclosure.

Although depicted as a physical device, in some embodiments, the computing device 600 may be implemented using virtual device(s), and/or across a number of devices (e.g., in a cloud environment). In some embodiments, the computing device 600 corresponds to or comprises an identification system, such as the identification system 105 of FIG. 1.

As illustrated, the computing device 600 includes a CPU 605, memory 610, storage 615, one or more network interfaces 625, and one or more I/O interfaces 620. In the illustrated embodiment, the CPU 605 retrieves and executes programming instructions stored in memory 610, as well as stores and retrieves application data residing in storage 615. The CPU 605 is generally representative of a single CPU and/or GPU, multiple CPUs and/or GPUs, a single CPU and/or GPU having multiple processing cores, and the like. The memory 610 is generally considered to be representative of a random access memory. Storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 635 (such as keyboards, monitors, etc.) are connected via the I/O interface(s) 620. Further, via the network interface 625, the computing device 600 can be communicatively coupled with one or more other devices and components (e.g., via a network, which may include the Internet, local network(s), and the like). As illustrated, the CPU 605, memory 610, storage 615, network interface(s) 625, and I/O interface(s) 620 are communicatively coupled by one or more buses 630. In the illustrated embodiment, the memory 610 includes a prediction component 650, and a training component 655.

Although depicted as discrete components for conceptual clarity, in some embodiments, the operations of the depicted components (and others not illustrated) may be combined or distributed across any number of components. Further, although depicted as software residing in memory 610, in some embodiments, the operations of the depicted components (and others not illustrated) may be implemented using hardware, software, or a combination of hardware and software.

In the illustrated embodiment, the prediction component 650 (which may correspond to the prediction component 115 of FIG. 1) may use trained machine learning models to identify the type(s) and/or size(s) of selected items (e.g., clothing items), as discussed above. For example, the prediction component 650 may use trained models such as the machine learning models 675 to classify or identify the item type(s) (e.g., the particular brand, fit, design, and the like) and/or item size.

In the illustrated embodiment, the training component 655 (which may correspond to the training component 120 of FIG. 1) may be used to train machine learning models to identify the type(s) and/or size(s) of selected items (e.g., clothing items), as discussed above. For example, the training component 655 may train models such as the machine learning models 675 to classify or identify the item type(s) (e.g., the particular brand, fit, design, and the like) and/or item size.

In the illustrated example, the storage 615 may include user data 670 and machine learning model(s) 675. In some embodiments, as discussed above, the user data 670 (which may correspond to the user data 110 of FIG. 1) may comprise information such as historical item selection records, social media records, and the like. Although depicted as residing in storage 615, in some embodiments, user data 670 and/or the machine learning models 675 may be stored in various other locations, including in memory 610.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding and/or following, reference is made to embodiments presented in this disclosure. However, the scope of the present disclosure is not limited to the described embodiments. Instead, any combination of the preceding and/or following features and elements, whether related to different embodiments or not, is contemplated to implement and practice contemplated embodiments. Furthermore, although embodiments disclosed herein may achieve advantages over other possible solutions or over the prior art, whether or not an advantage is achieved by a given embodiment is not limiting of the scope of the present disclosure. Thus, the preceding and/or following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Aspects of the described embodiments may take the form of an entirely hardware embodiment, an entirely software embodiment (including firmware, resident software, micro-code, etc.) or an embodiment combining software and hardware aspects that may generally be referred to herein as a “circuit,” “module” or “system.”

One or more of the described embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the described embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the described embodiments.

Aspects of the described embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a described manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged for the computing resources actually used (e.g. an amount of storage space consumed by a user or a number of virtualized systems instantiated by the user). A user can access any of the resources that reside in the cloud at any time, and from anywhere across the Internet. In context of the described embodiments, a user may access applications (e.g., the identification system 105 of FIG. 1) or related data available in the cloud. For example, the identification system 105 could execute on a computing system in the cloud and train and/or use machine learning models to predict clothing item sizes. In such a case, the identification system could train such models in the cloud, and store the trained models at a storage location in the cloud. Doing so allows a user to access this information from any computing system attached to a network connected to the cloud (e.g., the Internet).

While the foregoing is directed to one or more embodiments, other and further embodiments may be devised without departing from the basic scope thereof, and the scope thereof is determined by the claims that follow.

What is claimed is:

1. A method, comprising:
accessing a first set of images depicting a user selecting an item of clothing;
generating a first predicted type and a first predicted size of the item of clothing based on processing at least one of the first set of images using a machine learning model;
identifying, using a radio frequency identification (RFID) tag on the item of clothing, a true type and a true size of the item of clothing;
comparing the first predicted type and the first predicted size to the true type and the true size; and
training the machine learning model based on the comparison.

2. The method of claim 1, further comprising:
outputting at least one of: (i) the first predicted type and the first predicted size, or (ii) the true type and the true size, via a display; and
receiving, from the user, confirmation of the true type and the true size.

3. The method of claim 1, wherein generating the first predicted size comprises evaluating at least one of the first set of images to identify a location from which the user selected the item of clothing.

4. The method of claim 3, wherein generating the first predicted size comprises generating a predicted range of sizes based on the location.

5. The method of claim 1, wherein generating the first predicted size comprises one or more of:
(i) evaluating at least one of the first set of images to infer a size of the user;
(ii) evaluating historical item records to infer the true size; or (iii) evaluating one or more social media networks to infer the true size.

6. The method of claim 1, further comprising:
accessing a second set of images depicting a second user selecting a second item of clothing, wherein the second item of clothing does not have an RFID tag;
generating a second predicted type and a second predicted size of the second item of clothing based on processing at least one of the second set of images using the updated machine learning model; and
outputting the second predicted type and the second predicted size via a display.

7. The method of claim 6, further comprising:
determining a size of the second user;
determining that the second predicted size does not match the size of the second user; and
outputting, via the display, an indication that the second predicted size and the size of the second user do not match.

8. The method of claim 1, further comprising:
accessing a second set of images depicting the user exiting a fitting area; and
processing at least one of the second set of images using a machine learning model to predict whether the user retained the item of clothing.

9. A system comprising:
one or more memories collectively storing computer-executable instructions; and
one or more processors configured to collectively execute the computer-executable instructions and cause the system to perform an operation, comprising:
accessing a first set of images depicting a user selecting an item of clothing;
generating a first predicted type and a first predicted size of the item of clothing based on processing at least one of the first set of images using a machine learning model;
identifying, using a radio frequency identification (RFID) tag on the item of clothing, a true type and a true size of the item of clothing;
comparing the first predicted type and the first predicted size to the true type and the true size; and
training the machine learning model based on the comparison.

10. The system of claim 9, the operation further comprising:
outputting at least one of: (i) the first predicted type and the first predicted size, or (ii) the true type and the true size, via a display; and
receiving, from the user, confirmation of the true type and the true size.

11. The system of claim 9, wherein generating the first predicted size comprises evaluating at least one of the first set of images to identify a location from which the user selected the item of clothing.

12. The system of claim 9, wherein generating the first predicted size comprises one or more of:
(i) evaluating at least one of the first set of images to infer a size of the user;
(ii) evaluating historical item records to infer the true size; or (iii) evaluating one or more social media networks to infer the true size.

13. The system of claim 9, the operation further comprising:
accessing a second set of images depicting a second user selecting a second item of clothing, wherein the second item of clothing does not have an RFID tag;
generating a second predicted type and a second predicted size of the second item of clothing based on processing at least one of the second set of images using the updated machine learning model; and
outputting the second predicted type and the second predicted size via a display.

14. The system of claim 9, the operation further comprising:
accessing a second set of images depicting the user exiting a fitting area; and
processing at least one of the second set of images using a machine learning model to predict whether the user retained the item of clothing.

15. A computer program product comprising one or more computer-readable storage media having computer-readable program code collectively embodied therewith, the computer-readable program code collectively executable by one or more computer processors to perform an operation comprising:
accessing a first set of images depicting a user selecting an item of clothing;
generating a first predicted type and a first predicted size of the item of clothing based on processing at least one of the first set of images using a machine learning model;
identifying, using a radio frequency identification (RFID) tag on the item of clothing, a true type and a true size of the item of clothing;
comparing the first predicted type and the first predicted size to the true type and the true size; and
training the machine learning model based on the comparison.

16. The computer program product of claim 15, the operation further comprising:
outputting at least one of: (i) the first predicted type and the first predicted size, or (ii) the true type and the true size, via a display; and
receiving, from the user, confirmation of the true type and the true size.

17. The computer program product of claim 15, wherein generating the first predicted size comprises evaluating at least one of the first set of images to identify a location from which the user selected the item of clothing.

18. The computer program product of claim 15, wherein generating the first predicted size comprises one or more of:
(i) evaluating at least one of the first set of images to infer a size of the user;
(ii) evaluating historical item records to infer the true size; or
(iii) evaluating one or more social media networks to infer the true size.

19. The computer program product of claim 15, the operation further comprising:
accessing a second set of images depicting a second user selecting a second item of clothing, wherein the second item of clothing does not have an RFID tag;
generating a second predicted type and a second predicted size of the second item of clothing based on processing at least one of the second set of images using the updated machine learning model; and
outputting the second predicted type and the second predicted size via a display.

20. The computer program product of claim 15, the operation further comprising:
accessing a second set of images depicting the user exiting a fitting area; and
processing at least one of the second set of images using a machine learning model to predict whether the user retained the item of clothing.
